(19) United States
(12) Patent Application Publication
(10) Pub. No.: US 2006/0262105 A1
(43) Pub. Date: Nov. 23, 2006

(54) Pen-centric polyline drawing tool

(75) Inventors: Anthony S. Smith, Duvall, WA (US); Kamesh C. Tumsi Dayakar, Redmond, WA (US); Sergio A. Hernandez, Snoqualmie, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/131,182

(22) Filed: May 18, 2005

(51) Int. Cl. G09G 5/00

(52) U.S. Cl. 345/179

(57) ABSTRACT

A convenient and natural way to draw polyline shapes on a stylus-based computing device is described. A tool or other drawing function relies on a timing mechanism to identify the various vertices in a polyline shape. For example, the endpoint of each line may be detected responsive to the user stopping (or substantially stopping, such as by remaining within a predefined maximum movement threshold) movement of the tip of the stylus relative to the touch-sensitive surface. In addition, feedback is provided indicating that a line and/or its endpoint is about to commit to the polyline shape being drawn. Such feedback may be displayed shortly before the line and/or endpoint actually commits. Upon further delay without substantial movement of the stylus, the line and/or endpoint may then actually commit. A “snap” function is also provided that assists the user in fully closing the polyline shape, if desired.

### FIELD OF THE INVENTION

Aspects of the present invention are directed to the drawing of polyline shapes using a pen-based computer user interface.

### BACKGROUND OF THE INVENTION

Many drawing applications provide a way to draw a polygon. For example, the Microsoft PAINT drawing application, the Microsoft VISIO diagramming application, the Microsoft POWERPOINT presentation application, and the Microsoft WORD word processing application all provide a range of polygon drawing tools. These tools are optimized for use with a mouse, which has been a standard input device used with graphical user interfaces for a long time.

Also becoming more popular recently is the provision for stylus-based input devices for all types of computers. A stylus-based input device essentially includes a stylus, or pen, that the user manipulates relative to a touch-sensitive input surface. For instance, personal digital assistants (PDAs) and tablet-style personal computers commonly use stylus-based input devices. Unfortunately, current polygon drawing tools are optimized for a mouse and are therefore difficult, if not impossible, to use with a stylus-based input device. For example, some current polygon drawing tools require the user to lift the stylus away from the touch-sensitive surface in order to identify each vertex of the polygon being drawn, as well as require the user to double-click to indicate the end of a polygon drawing operation. This is very unnatural and mouse-centric.

There is therefore a need for a polyline shape drawing tool that provides a natural and convenient way for drawing polygons using a stylus or other similar input devices.

### SUMMARY OF THE INVENTION

Aspects of the present invention are directed to the computer-implemented drawing of polyline shapes that is more convenient to a user utilizing a stylus-based input device. A software, hardware, and/or firmware tool is provided that does not necessarily rely on the user having to lift the stylus to identify each vertex of a polyline shape being drawn. Instead, the tool may rely on a timing mechanism to identify the various vertices. For example, the endpoint of each line may be detected responsive to the user stopping (or substantially stopping, such as by remaining within a predefined maximum movement threshold) movement of the tip of the stylus relative to the touch-sensitive surface. Or, some other mechanism may be used to identify the various vertices, such as by detecting a change (e.g., an increase) in stylus pressure at each vertex.

Further aspects of the present invention are directed to providing visual or other feedback that a line and/or its endpoint is about to commit to the polyline shape being drawn. Such feedback may be displayed shortly before the line and/or endpoint actually commits. Upon further delay without substantial movement of the stylus, the line and/or endpoint may then actually commit.

Still further aspects of the present invention allow the polyline shape to be aborted or ended simply by removing the stylus from the touch-sensitive surface. Alternatively, the user may take another action such as by double-tapping the stylus or by pressing a keyboard key or a button on the stylus. The key, button, or double-tapping may alternatively be used to commit a line and/or an endpoint to the polyline shape, instead of using the above-mentioned timing mechanism.

Still further aspects of the present invention are directed to providing for a “snap” function as the stylus returns, after drawing two or more lines in the polyline shape, to the initial point in the polyline shape. In particular, if the tip of the stylus is sufficiently close to the initial point, then when the endpoint and/or line is committed, that endpoint is adjusted to be equal to the initial point, thereby completing a closed polyline shape more accurately than could be expected from the user's raw hand movements. In essence, the snap function assists the user in fully closing the polyline shape, if desired.

These and other aspects of the invention will be apparent upon consideration of the following detailed description of illustrative embodiments.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative computer that may be used to implement various aspects of the present invention.

FIG. 2 is a plan view of an illustrative computing device using a pen-based user interface.

FIG. 3 shows illustrative polyline shapes.

FIGS. 4-9 are consecutive illustrative screenshots showing a polygon being drawn.

FIG. 10 is an illustrative screenshot of an aborted polygon.

FIG. 11 is a flowchart of illustrative steps that may be taken in a polygon drawing process.

### DETAILED DESCRIPTION OF ILLUSTRATIVE EMBODIMENTS

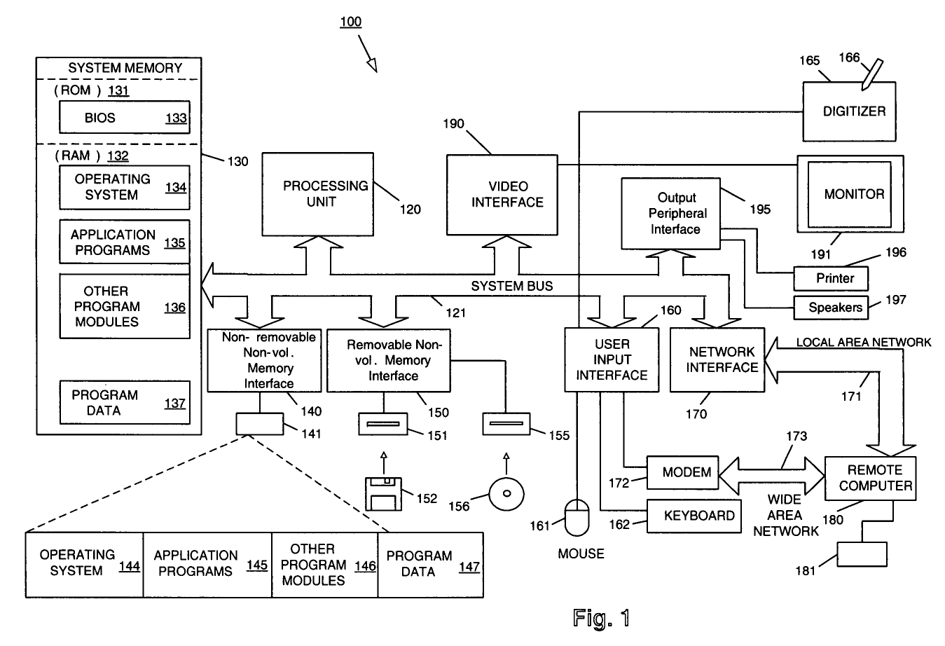

FIG. 1 illustrates an example of a suitable computing system environment 100 in which aspects of the invention may be implemented. Computing system environment 100 is only one example of a suitable computing environment and is not intended to suggest any limitation as to the scope of use or functionality of the invention. Neither should computing system environment 100 be interpreted as having any dependency or requirement relating to any one or combination of components illustrated in illustrative computing system environment 100.

The invention is operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. The invention may also be operational with distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 100. Components of computer 100 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 100 typically includes a variety of computer-readable media. Computer readable media can be any available media that can be accessed by computer 100 such as volatile, nonvolatile, magnetic, optical, removable, and non-removable media. By way of example, and not limitation, computer-readable media may include computer storage media and communication media. Computer storage media may include volatile, nonvolatile, magnetic, optical, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium that can be used to store the desired information and which can accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combination of multiple computer-readable media, are both intended to be included within the scope of the term “a computer-readable medium” as used in both this specification and the claims. For example, a computer readable medium includes a single optical disk, or a collection of optical disks, or an optical disk and a memory.

System memory 130 includes computer storage media in the form of volatile and/or nonvolatile memory such as ROM 131 and RAM 132. A basic input/output system (BIOS) 133, containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions, including operating system 134, application programs 135, other program modules 136, and program data 137.

Computer 100 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. 1 provide storage of computer-readable instructions, data structures, program modules and other data for computer 100. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 100 through input devices such as a keyboard 162 and a pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 191 or other type of display device is also coupled to system bus 121 via an interface, such as a video interface 190. Video interface 190 may have advanced 2D or 3D graphics capabilities in addition to its own specialized processor and memory.

Computer 100 may also include a touch-sensitive device 165, such as a digitizer, to allow a user to provide input using a stylus 166. Touch-sensitive device 165 may either be integrated into monitor 191 or another display device, or be part of a separate device, such as a digitizer pad. Computer 100 may also include other peripheral output devices such as speakers 197 and a printer 196, which may be connected through an output peripheral interface 195.

Computer 100 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 100, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 100 is coupled to LAN 171 through a network interface or adapter 170. When used in a WAN networking environment, computer 100 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 100, or portions thereof, may be stored remotely such as in remote storage device 181. By way of example, and not limitation, FIG. 1 illustrates remote application programs 182 as residing on memory device 181. It will be appreciated that the network connections shown are illustrative, and other means of establishing a communications link between the computers may be used.

As discussed previously, touch-sensitive device 165 may be a device separate from or part of and integrated with computer 100. In addition, any or all of the features, subsystems, and functions discussed in connection with FIG. 1 may be included in, coupled to, or embodied integrally as part of, a tablet-style computer. For example, computer 100 may be configured as a tablet-style computer or a handheld device such as a PDA where touch-sensitive device 165 would be considered the main user interface. In such a configuration touch-sensitive device 165 may be considered to include computer 100. Tablet-style computers are well-known. Tablet-style computers interpret gestures input to touch-sensitive device 165 using stylus 166 in order to manipulate data, enter text, create drawings, and/or execute conventional computer application tasks such as spreadsheets, word processing programs, and the like. Input may not only be made by stylus 166, but also by other types of styli such as a human finger.

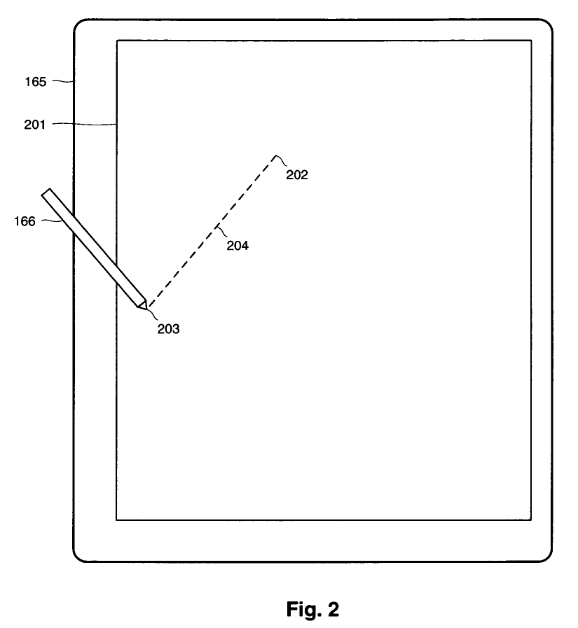

FIG. 2 shows an illustrative embodiment of touch-sensitive device 165 and stylus 166. Stylus 166 may be used to make various types of input gestures on a touch-sensitive surface 201 of touch-sensitive device 165. A pen-down input is one where the tip of stylus 166 is brought down from mid-air to physically contact touch-sensitive surface 201. A pen-up input is one where the tip of stylus 166 is removed from being in physical contact with touch-sensitive surface 201. When using stylus 166, a tap is a pen-down input quickly followed by a pen-up input. When using stylus 166, a hold input is one where the tip of stylus 166 is in physical contact with touch-sensitive surface 201 while remaining in one location (or nearly one location) on touch-sensitive surface 201. Although ideally a hover input would result from stylus 166 remaining in a single location for a period of time, in reality most users are incapable of holding a stylus so precisely. Thus, a hold input includes an input where the stylus 166 is held substantially still for a period of time, such as within an area only two or three pixels (or some other smaller or larger tolerance) in diameter. A hover input is one where the tip of stylus 166 is in midair (i.e., not in physical contact with touch-sensitive surface 201) but near enough to touch-sensitive surface 201 that touch-sensitive device 165 still detects the presence of stylus 166. Stylus 166 may provide a hover input either by moving in midair or by pausing over in midair over one location of touch-sensitive surface 201. A drag input, when using stylus 166, is one where the tip of pen 166 is in physical contact with touch-sensitive surface 201 while moving across touch-sensitive surface 201. These types of stylus inputs, and the detection of these inputs, are each individually well known in the art.

It should be noted that some of these inputs may be similarly performed by other types of input devices that do not use a touch-sensitive device. For example, a left-mouse-button-down (or right-mouse-button-down) input may be performed where the user presses down the left (or right) button of a mouse. Similarly, a left-mouse-button up (or right mouse-button-up) input may be performed where the user releases the left (or right) button of the mouse. A tap, when performed by the mouse, is a left-mouse-button-down input quickly followed by a left-mouse-button-up input. This tap input performed by a mouse may be considered for purposes of the present invention to be functionally equivalent to a tap input performed by a stylus. A drag, when performed by the mouse, is where the left button is pressed down while the mouse is moved across a surface. This drag input performed by a mouse may be considered for the purposes of the present invention to be functionally equivalent to a drag input performed by a stylus. A mouse may even perform what is considered herein to be the functional equivalent of a stylus hold input by remaining still in one location on a surface while the left mouse button is depressed. A mouse may further perform what may be considered for purposes of the present invention the functional equivalent of a hover input of a stylus by moving across a surface while the left mouse button is in a released position. Again, these types of mouse inputs, and the detection of these inputs, are each individually well known in the art.

Although the various examples that will be discussed herein will refer to the user of a stylus, it should be kept in mind that many of these examples may alternatively be implemented by a mouse or other similar input device. Accordingly, it will be noted that the term “down input” in both this specification and the claims is intended herein to include both a pen-down input and a left-mouse-button-down input, and the term “up input” in both this specification and the claims is intended to include both a pen-up input and a left-mouse-button-up input. Thus, inputs as referred to in both this specification and the claims are intended to include both stylus inputs and mouse inputs unless otherwise specified. For example, the term “drag input,” in both this specification and the claims, is intended to include both a stylus drag input and a mouse drag input. As another example, the term “hold input,” in both this specification and the claims, is intended to include both a stylus hold input and a mouse hold input.

As shown in FIG. 2, stylus 166 has just performed a drag input by dragging from location 202 on touch-sensitive surface 201 to location 203. In response to the drag input, computer 100 causes a line 204 to be drawn between locations 202 and 203. This is true even though stylus 166 may not have taken the path defined by line 204 to travel from location 202 to location 203. Location 202 represents the location where the drag input began, and location 203 represents the current location of the drag input. As the drag input is performed, location 202 remains fixed while location 203 and displayed line 204 may be continuously and dynamically updated with the current position of the tip of stylus 166. In FIG. 2, it is assumed that touch-sensitive surface 201 is integrated with a display, such as monitor 191. However, the display may be separate from touch-sensitive surface 201 and/or from touch-sensitive device 165.

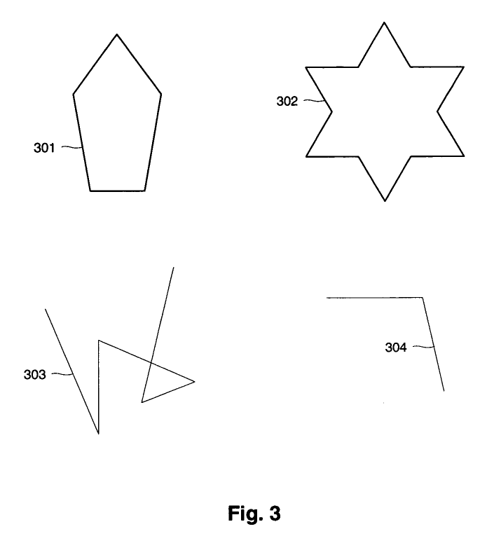

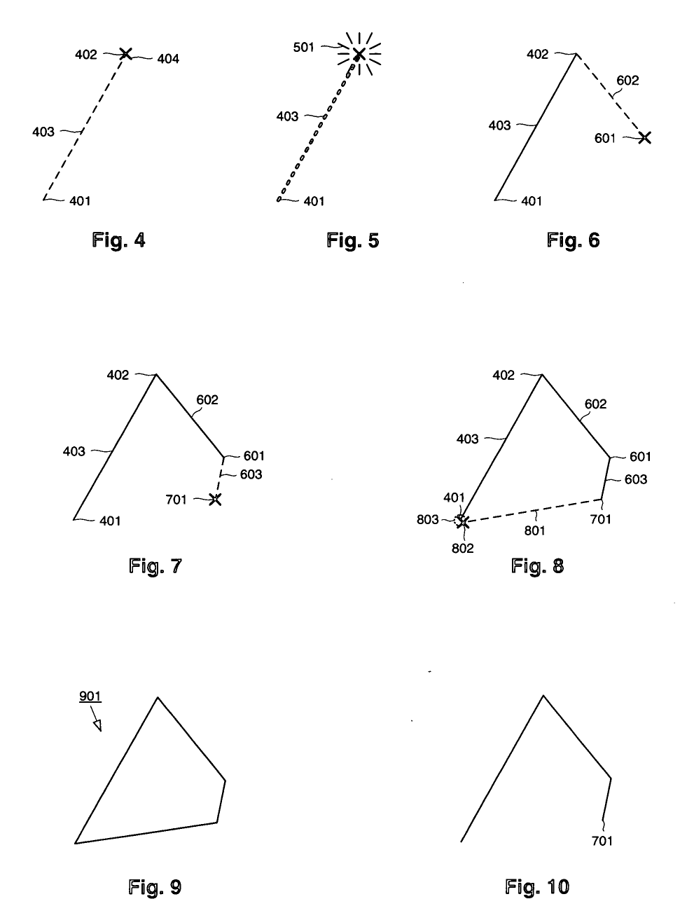

Aspects of the present invention will now be discussed in accordance with illustrative embodiments and with reference to FIGS. 4-11. These aspects may be used to draw a polyline shape. A polyline shape is an open or closed shape that consists of a plurality of linear sides, where each side is joined either to one other side at one endpoint or to two other sides at two endpoints. A polyline may be a regular or irregular polygon. For example, referring to FIG. 3, polyline shapes 301 and 302 are each a polygon. A polyline shape may also be a polyline shape other than a polygon, such as illustrative by polyline shapes 303 and 304.

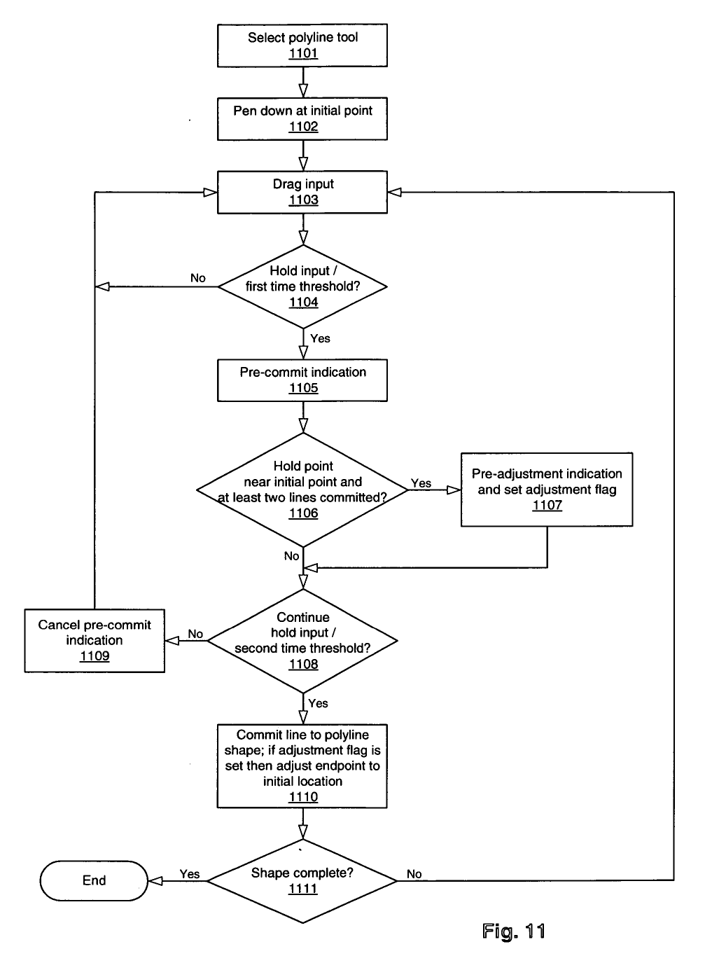

Referring to FIG. 11, an illustrative method that draws a polyline shape will now be described that may be performed on a computer such as computer 100. The various steps discussed herein may be embodied as computer-executable instructions stored on a computer-readable medium. Also, although it will be assumed that the user is utilizing a stylus, a mouse or other similar input device may alternatively be used. In step 1101, the user or an application selects a polyline tool. The polygon tool may be a stand-alone software application or it may be a function or mode provided by a larger software application such as a drawing application. To put the polyline tool in context, the polyline tool may be one of many other tools or modes that are available to the user. For example, the user may select a circle tool to assist the user with drawing a circle, or a rectangle tool for drawing a rectangle. When the user desires to draw a polyline shape, then, the user may select the polyline tool until the user desires to perform a different function or until the polyline shape is successfully completed.

In step 1102, the user may perform a pen-down input at an initial location on touch-sensitive surface 201 of touch-sensitive device 165. In response, computer 100 may provide visual feedback to the user by displaying a cursor at the initial location of stylus 166. Subsequent to the pen-down input, and while stylus 166 remains down on touch-sensitive surface 201, the user may perform a drag input with stylus 166 in step 1103. In response, computer 100 may cause a line to be displayed between the initial location and the current location of stylus 166. For example, referring to FIG. 4, the initial location is indicated as element 401 and the current location of stylus 166 is indicated as element 402. As shown, a line 403 is displayed extending between initial location 401 and current location 402. Line 403 is dynamically updated to reflect any movement of current location 402. Current location 402 at any given time may be indicated by a displayed cursor 404 that is also dynamically updated to reflect any movement of current location 402.

Next, in step 1104, computer 100 determines whether a hold input (and/or some other particular input) is being performed at current location 402. To determine whether a hold input is being performed, computer 100 may determine whether stylus 166 has been held for at least a first threshold amount of time. If so, then computer 100 determines that a hold input has been performed. If not, then computer 100 does not consider this a sufficient hold input and therefore determines that, for all relevant purposes, a hold input has not yet been performed. The first threshold amount of time may be any amount of time, such as a half second, one second, or more than one second.

If a hold input has not been detected in step 1104, then computer 100 continues to wait and test for a hold input until it occurs. Alternatively, the user may lift stylus 166 away from touch-sensitive surface 201 without performing a hold input. In this situation, the process in FIG. 11 would be aborted. However, if a hold input is detected in step 1104, then in step 1105, computer 100 may generate an indication to the user. This indication represents the condition that line 403 (and/or endpoint 402) is about to be committed to (i.e., identified as being part of) the polyline shape being drawn. In other words, this indication is a warning to the user that, unless the user removes stylus 166 or continues the previous drag input, then line 403 as drawn thus far will become part of the polyline shape being drawn. This pre-commit indication may be a visual and/or audible indication. For example, referring to FIG. 5, the user is provided two simultaneous indications. One of these pre-commit indications is that line 403 changes format. In FIG. 4, line 403 was a first type of broken line, while in FIG. 5 line 403 is a different second type of broken line. In addition, while in FIG. 4 line 403 was constantly displayed, in FIG. 5 line 403 is flashing alternately between a solid line and a broken line. These format types of merely illustrative, and any change in line format may be performed, such as but not limited to a change in solid-versus broken, a change in how broken the line is, a change in line thickness, and/or a change in line color.

The other pre-commit indication shown in FIG. 5 that line 403 is about to commit to the polyline shape is that a separate indication 501 is displayed, in this example surrounding cursor 404. This separate indication 501 may be any type of indication, and the one shown is merely illustrative. Also, separate indication 501 may be shown anywhere relative to cursor 404 and/or line 403, or even in a dedicated or fixed portion of the display. The two types of indications shown in FIG. 5 may be used together, or only one of the two types of indications may be provided.

In addition, computer 100 may determine in step 1106 whether the current location of the hold input is near initial location 401. To determine whether the hold input is near initial location 401, the distance between the hold input and initial location 401 may be compared with a threshold distance. At the moment, it will be assumed that the hold input, which is currently at location 402, is not near initial location 401. Therefore, in step 1108, computer 100 continues to provide the pre-commit indication while the hold input continues. This pre-commit indication continues until a second threshold amount of time is reached without the hold input being aborted. The second threshold amount of time occurs after the first threshold amount of time. For example, the second threshold amount of time may be a less than a second (such as a half second), in the range of one to two seconds, or even more than two seconds beyond the first threshold amount of time.

If the hold input continues at least up to the second threshold amount of time, then in step 1110 the currently drawn line (in this example, line 403) is committed to the polyline shape being drawn. In other words, line 403 is now considered part of the polyline shape. This means that further drag input by stylus 166 will result in a new line being drawn, without affecting the endpoints of committed line 403. To signify to the user that line 403 is now committed, line 403 may be drawn in yet a different third format. In this example, line 403 is now drawn as a solid line in FIG. 6. However, any line format that differs from the line format used when drawing the line (e.g., FIG. 4) and/or during the pre-commit indication phase (e.g., FIG. 5) may be used.

Next, in step 1111, computer 100 determines whether the polyline shape being drawn is complete. This may be determined by, for example, a particular user input (e.g., by removing stylus 166 away from touch-sensitive surface 201, by double-tapping stylus 166 on touch-sensitive surface 201, by pressing the ESC key on a keyboard, or by pressing a button on stylus 166), by detecting that the endpoint of the most recent line committed is the same as initial location 401, or by detecting that a predetermined number of lines have been committed to the polyline shape. In the present example, location 402 is not the same as location 401, and in this example it is assumed that the polyline shape has not yet been completed. Accordingly, the process returns to step 1103 so that a new drag input may be received in order to draw the next line in the polyline shape. This process may thus be repeated for each next line in the polyline shape. For instance, as shown in FIGS. 6-8, line 602 (having endpoints 402 and 601) and line 603 (having endpoints 601 and 701) are drawn and committed in the same manner as line 403.

Although in the present example, a hold input is used in steps 1104 and 1108 to commit a line to the polyline shape, other types of non-drag inputs may be used for this purpose. For instance, when using a stylus, the user may tilt and/or rotate the stylus to indicate an intention to commit the line. In such a case, the user may be required to maintain at least a certain degree of stylus tilt and/or rotation for at least a first threshold amount of time in order to receive the pre-commit indication and for at least an additional second threshold amount of time in order to actually commit the line. Or, the user may apply extra downward pressure by the stylus onto the touch-sensitive surface in order to commit the line currently being drawn. Conventional stylus-sensitive devices are capable of detecting the tilt, rotation, and applied pressure of a stylus. Alternatively, the user may press a key on a keyboard or a button on the stylus (or mouse) to commit the line currently being drawn.

Referring to FIG. 8, the process is again repeated for what the user intends to be the final line of the polyline shape, line 801. In this case, line 801 has an endpoint 802 that is close to initial location 401, as determined at step 1106. Therefore, the process moves to step 1107, wherein computer 100 generates an indication that the polyline shape being drawn would be completed if the current line 801 is committed. This because, even though location 802 is not exactly in the same location as location 401, it is considered close enough that computer 100 would cause the endpoint of line 801 to be equal to initial location 401 instead of actual location 802, so that the polyline shape may be successfully completed. In this respect computer 100 may make a determination as to whether it is likely that the user intends to complete the polyline shape and to set the final endpoint 802 to be equal to initial location 401. In doing so, computer 100 may determine whether endpoint 802 is within a region defined relative to initial location 401. For example, it may be determined whether endpoint location 802 is within a first predetermined threshold distance of initial location 401, such as within a predetermined number of pixels (e.g., within two or three pixels) of initial location 401. If so, then computer 100 may set a flag (called herein an adjustment flag) to TRUE, indicating that the final endpoint of the line being drawn should be adjusted at step 1110 to be the same as the initial location. Otherwise, the adjustment flag is FALSE.

In addition, computer 100 may generate a displayed and/or audible indication that actual location 802 is close to initial location 401. Such a “pre-adjustment” indication may be in the form of, for example, a circle having a radius equal to the threshold distance and centered at initial location 401, as shown in FIG. 8 as indicator 803. The pre-adjustment indication may be shown in response to location 802 becoming close to initial location 401 or prior to location 802 becoming close. For instance, the pre-adjustment indication may be provided responsive to location 802 being within a second predetermined threshold distance from initial location 401, wherein the second threshold distance is greater than the first threshold distance.

Thus, assuming that the user has continued the hold input at location 802, in FIG. 9 a polyline shape 901 is now formed. At step 1111, computer 100 determines whether the polyline shape 901 is complete. Since in this example the most recent endpoint 802 was adjusted to be the same as the initial location 401, then polyline shape 901 is complete. Accordingly, the process shown in FIG. 9 ends. This may mean that the polyline tool/mode being implemented is ready for a new polyline shape to begin being drawn, or it may bean that the polyline tool/mode is terminated and another input mode is activated.

If at any time the user indicates that the polyline shape should be completed or aborted, the process of FIG. 11 may be stopped. Such an indication by the user may include removal of stylus 166 from touch-sensitive surface 201 or by pressing a key such as the ESC key. For example, if the user removes stylus 166 from touch-sensitive surface 201 after committing line 603 at location 701, then the resulting drawn polyline shape may be as shown in FIG. 10.

Thus, a new polyline drawing tool has been described that allows a user to conveniently input a polyline shape, such as a polygon, using a stylus on a touch-sensitive surface, without necessarily having to remove the stylus from the touch-sensitive surface until the polyline shape is complete. The various mechanisms described herein provide a much more natural user interface that is optimized for use with a stylus-based input device, although the mechanisms may also be used with a mouse or other similar input device if desired.

What is claimed is:

1. A computer-readable medium storing computer-executable instructions for performing steps comprising:
receiving a first drag input from a first location;
detecting a hold input after the first drag input, wherein the hold input occurs at a different second location;
displaying a first line in a first format having endpoints of the first location and a the second location;
responsive to the hold input, displaying a first indication to a user;
determining whether the hold input has continued; and
responsive to the hold input having continued, displaying the first line in a second format different from the first format.

2. The computer-readable medium of claim 1, wherein the first drag input is a first stylus drag input and the hold input is a stylus hold input.

3. The computer-readable medium of claim 1, wherein the first drag input is a first mouse drag input and the hold input is a mouse hold input.

4. The computer-readable medium of claim 1, wherein the step of displaying the first indication includes displaying the first line in a third format different from the first and second formats.

5. The computer-readable medium of claim 1, wherein the computer-executable instructions are further for performing steps including:
determining whether the second location is close to a third location different from the first and second locations; and
responsive to determining that the second location is close to the third location, displaying a second indication.

6. The computer-readable medium of claim 5, wherein the second indication is a circle centered around the third location.

7. The computer-readable medium of claim 1, wherein the computer-executable instructions are further for performing steps including:
determining whether the second location is close to a third location; and
responsive to determining that the second location is close to the third location, displaying the first line such that the first line has endpoints at first location and the third location.

8. The computer-readable medium of claim 7, wherein the computer-executable instructions are further for displaying a second line different from the first line and having an endpoint at the third location.

9. A computer-readable medium storing computer-executable instructions for performing steps comprising:
receiving a first drag input followed by a first hold input;
displaying a first line having endpoints of a beginning of the first drag input and a current location of the first drag input and a location of the first hold input;
receiving a second drag input; and
displaying a second line having endpoints of the location of the first hold input and a current location of the second drag input, while the first line remains displayed.

10. The computer-readable medium of claim 9, wherein the step of displaying the second line includes displaying the second line in a first format while the first line is displayed in a second format different from the first format.

11. The computer-readable medium of claim 9, wherein the computer-executable instructions are further for performing steps including:
receiving a second hold input following the second drag input;
determining whether a location of the second hold input is close to a predetermined location different from the location of the second hold input; and
responsive to determining that the location of the second hold input is close to the predetermined location, displaying the second line such that the second line has endpoints at the first location and the predetermined location.

12. The computer-readable medium of claim 11, wherein the step of displaying the second line to have endpoints of the location of the first hold input and the current location of the second drag input includes displaying the second line in a first format, and
wherein the step of displaying the second line such that the second line has endpoints at the first location and the predetermined location includes displaying the second line in a second format different from the first line.

13. A computer-readable medium storing computer-executable instructions for performing steps comprising:
receiving a plurality of drag inputs and non-drag inputs between the drag inputs; and
displaying a polyline shape having corners at locations of the non-drag inputs.

14. The computer-readable medium of claim 13, wherein the non-drag inputs are each a hold input.

15. The computer-readable medium of claim 13, wherein the non-drag inputs are each a button press.

16. The computer-readable medium of claim 13, wherein the non-drag inputs are each a stylus tilt or stylus rotation.

17. The computer-readable medium of claim 13, wherein the polyline shape is a polygon.
